(19) United States
(12) Patent Application Publication
(10) Pub. No.: US 2008/0110098 A1
(43) Pub. Date: May 15, 2008

(54) DEVICE AND METHOD FOR USE WITH MOTORIZED VEHICLE

(76) Inventor: Jason Frederick, Lakewood, CO (US)

Correspondence Address: Michael R. Henson & Associates, LLC, 5613 DTC Parkway, Suite 240, Greenwood Village, CO, 80111, US

(21) Appl. No.: 11/845,639

(22) Filed: Aug. 27, 2007

Related U.S. Application Data
(60) Provisional application No. 60/858,657, filed on Nov. 14, 2006.

(51) Int. Cl. F02F 11/00

(52) U.S. Cl. 49/463; 55/385.3

(57) ABSTRACT

Broadly speaking, the present disclosure relates to devices and methods for use with motorized vehicles. Motorized vehicles often have air intake openings in communication with at least one air filter. Air intake openings may have intake profiles of a selected shape. One aspect of the present disclosure relates to a device that comprises at least a first plug, but preferably first and second plugs each having an associated plug profile which is congruent with, and enlarged relative to, it associated intake profile. One or more plugs may comprise a body formed from a resilient material such that it is formable into a compressed state for insertion into an air intake opening and operative to return towards an uncompressed state to seal the intake opening against intrusion of contaminants. Other aspects of the present invention include a connector assembly joining first and second plugs and a method.

### CROSS-REFERENCE TO RELATED APPLICATION

The present application claims the benefit of U.S. provisional application No. 60/858,657 filed on Nov. 14, 2006, the entire disclosure of which is incorporated herein by reference.

### BACKGROUND

The design of many modern day, off-road motorized vehicles utilize a foam filter to guard against dirt and other debris entering into the vehicle's carburetor and ultimately its engine. The air filter, typically foam, is often treated with a sticky oil substance to attract any unwanted foreign material that may penetrate to the air filter. To allow sufficient air flow to the engine, often times there are holes positioned around the air filter to permit sufficient air flow to the engine, thus providing for optimal performance. These holes, sometimes referred to as air intake openings or ventilation portals, are positioned on the air box or surrounding structures of the air filter.

By their very nature, off-road vehicles often become very soiled with mud and dirt during the riding activity. This is particularly true for highly advanced four-stroke engines used in closed course profession Motocross or Enduro racing competition, but also two stroke engines to a lesser degree. With such vehicles, it is even more important today to prevent dirt or other unwanted contaminants from reaching the engine components. Contamination can often lead to very costly engine repairs. Thus, to maintain optimum performance and preserve engine servicability of the vehicle, every attempt should be made to keep dirt and/or other unwanted contaminants from entering into the air box.

Such a need arises not only while the vehicle may be in use, but during a washing process. It is not uncommon for operators to simply stuff rags into the air intake openings while washing their vehicles. Such an approach may be effective to some degree; however, rags absorb water and cannot properly seal the air intake openings, particularly when there may be different water pressures involved from a hose, a power washer, or other water delivery system. In addition, stuffing rags into the air boxes can be time-consuming and cumbersome.

Accordingly, a need remains to appropriately seal the air intake openings of motorized vehicles to prevent contamination under such circumstances. The present invention is particularly suited to address that need.

### SUMMARY

Provided are devices and methods for use with motorized vehicles. Broadly speaking, the motorized vehicle has first and second air intake openings in communication with at least one air filter. The first air intake opening has a first intake profile of a selected shape, while the second intake opening has a second intake profile of a selected second shape.

Broadly, the device comprises at least a first plug, but preferably first and second plugs each having an associated plug profile which is congruent with, and enlarged relative to, its associated intake profile. The first plug comprises a first body formed from a resilient material such that it is formable into a compressed state for insertion into the first air intake opening and operative to return towards an uncompressed state to seal the first intake opening against intrusion of contaminants. Similarly, the second plug has an associated second body formed from an associated resilient material to also be formable into a compressed state for insertion into the second air intake opening, and operative to return towards an uncompressed state to seal the second air intake opening against intrusion of contaminants.

In the exemplary embodiments disclosed, the devices are particularly suitable for use during a wash cycle of a motorcycle in which a left air intake opening is in communication with an air filter along a left intake pathway, and a right intake opening is in communication with the same air filter along a right intake pathway. Preferably also, the left and right air intake openings have a common profile and become sealed by their associated plugs against intrusion of water during the wash cycle.

In one exemplary embodiment a connector assembly joins the first and second plugs. In another exemplary embodiment, the first and second plugs are compressible for removable insertion into their respective air intake openings, and a connector assembly, or an elongated connector, joins them.

In the exemplary embodiments the first and second plugs have common profiles, and may be triangular for example. More preferably, their bodies have identical constructions and are each formed from the same resilient material. To this end, a suitable rubber compound or neoprene material have the characteristics of durability, washability, ability to conform to slight variances in shape and repel water, is preferred.

The connector assembly includes at least one, but preferably a pair of strap portions each mounted to an associated plug, with the strap portions being coupled together by a connector element such as a carabineer. In another embodiment, the connector assembly is sufficiently elongate to permit the first and second plugs to be inserted into their respective openings without becoming disjoined from one another or the connector element. In this embodiment, the connector element straddles the seat of the motorcycle during the wash cycle.

According to the described method, the left and right air intake openings of the motorcycle have a common profile. First and second resilient plugs are provided each having an associated plug profile which is congruent with, and larger than, the common profile. The first plug is compressed in a direction transverse to the first airflow pathway and inserted into the left opening, whereby the first plug expands towards an uncompressed state to seal the first opening against intrusion of water during the wash cycle. Similarly, the second plug is compressed in a direction transverse to the second airflow pathway and inserted into the right opening, whereby the second plug expands towards an uncompressed state to seal the second opening against intrusion of water during the wash cycle. The order in which the first and second plugs are inserted is of little consequence. Also according to the method, a connector is provided between the first and second plugs such that when they are inserted into their respective openings, the connector spans therebetween and straddles the seat of the motorcycle.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a left side view of an individual washing a motorized vehicle, more specifically, a motorcycle;

FIG. 2 is a perspective view of representative air box for a motorcycle, such as depicted in FIG. 1, with a portion thereof removed to reveal its interior;

FIG. 3 is a perspective view of the representative air box of FIG. 2 provided with a pair of plugs inserted into the air intake openings;

FIG. 4 is an exploded perspective view, broken away, of a portion of the air box of FIG. 3, prior to insertion of one of the plugs;

FIG. 5 is a perspective view of device according to a first exemplary embodiment which comprises a plug and a connector assembly;

FIG. 6 is an exploded perspective view of the plug and connector assembly shown in FIG. 5;

FIG. 7 is a perspective view of device according to a second exemplary embodiment, comprising a pair of plugs joined by a connector assembly; and

FIG. 8 is a perspective view of an alternative construction of the device, shown as a pair of plugs joined by a connector element.

### DETAILED DESCRIPTION OF THE EXEMPLARY EMBODIMENTS

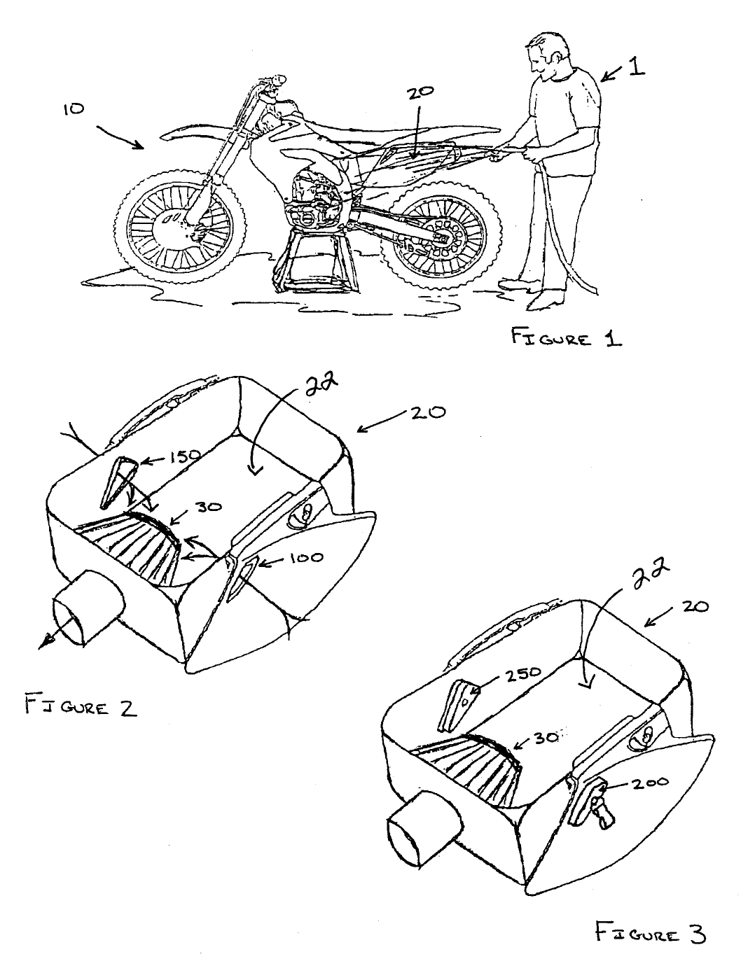

In FIG. 1, a motorized vehicle in the form of a motorcycle 10 is shown being cleaned by an individual 1 with a water source, such as a hose. The purpose of spraying motor vehicle 10 could be to clean it after its use in an environment where it became soiled. The means of cleaning a motorized vehicle during a wash cycle can take many forms, including but not by way of limitation, hand washing, an automated wash system, spraying with a solvent, wiping with a cloth, or any other suitable cleaning method. The extent of cleaning can also vary, from merely hosing down a motorized vehicle with water, or some other solvent, to disassembling the vehicle and cleaning constituent parts in detail, employing a host of cleaning, polishing and protective agents. Furthermore, while FIG. 1 illustrates a motorcycle, it is contemplated that the motorized vehicle 10 can vary and include a variety of forms, for example and not by way of limitation, an ATV, a lawnmower, a golf cart, a snow mobile, a water craft, a car, a truck, a bus, a passenger vehicle, or any other motorized form, whether for transportation or otherwise, which is suitably constructed to benefit from the teachings herein.

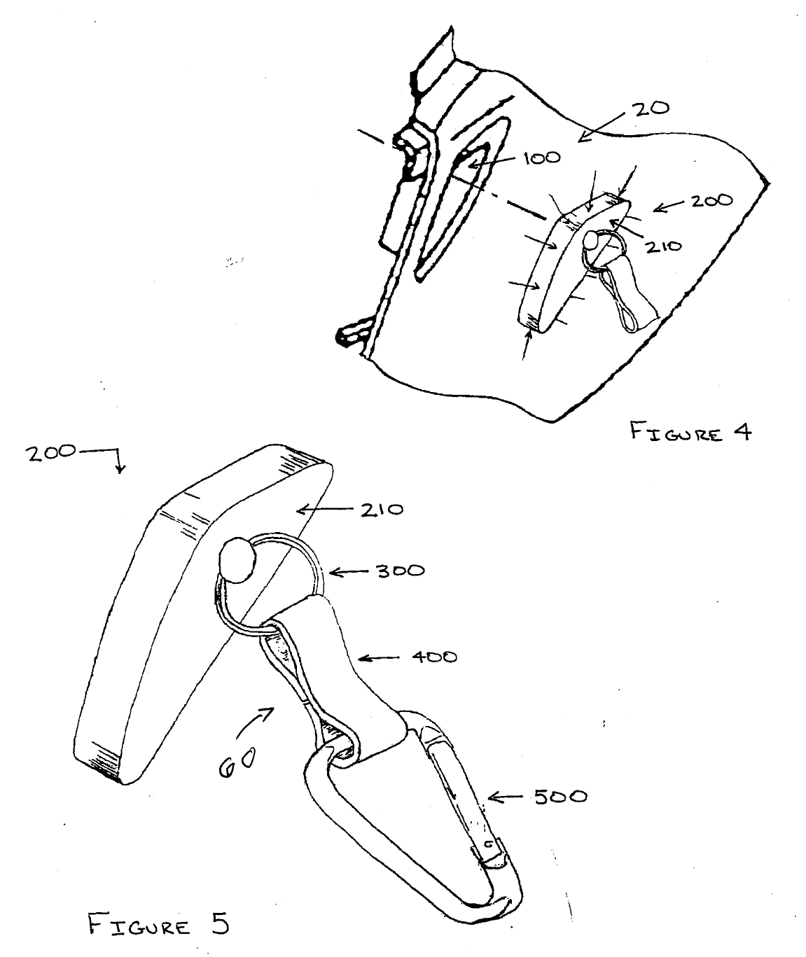

With reference to FIGS. 2 and 3, an air box 20 for motorcycle 10 can have one or more air intake openings. Here, the air intake openings are shown in FIG. 2 as a first air intake opening 100 and a second air intake opening 150. It is contemplated that there can be one or more air intake openings in the air box 20, depending on the nature of the vehicle. It is contemplated that the air intake openings can be of various shapes and sizes. Furthermore, a motorized vehicle 10 can have one or more such air boxes 20. Lastly, it is contemplated that a given air box 20 may contain one or more air filters 30. Thus, it should be readily understood the depicted construction of air box 20 in various ones of the figures is for representative purposes only.

When being washed, transported, painted, or otherwise exposed to an adverse environment, the air intake openings, 100 and 150, of air box 20 may be susceptible to the intrusion of foreign contaminates or debris, e.g. water, dirt soap, polish, paint, or other unwanted particulate matter, into air box's interior 22. Some potential problems posed by foreign contaminants entering an air box 20 is that they can diminish air flow and/or jeopardize the integrity of the air filter 30 contained therein, thus adversely affecting the air filter's function, life span or motor performance, to name a few. This is particularly true while washing (i.e. during a wash cycle), but can also be a problem during vehicle operation, for example, during motocross or Enduro racing. To assist in remedying this problem, the air intake openings 100 and 150 can be suitably sealed to prevent the passage of unwanted contaminants into the air box 20. That is, they can be sealed to prevent any matter from entering into the air box's interior, or particular types of unwanted contaminants such as water and dirt, for example.

With reference to FIGS. 2 and 3, a first (or left) air intake opening 100 may be engaged and sealed by a first plug 200 and a second (or right) air intake opening 150 may be engaged and sealed by a second plug 250. As such, when the motorcycle vehicle is exposed to an adverse environment—that is, one in which it is susceptible to the intrusion of unwanted matter into the air box interior—, and both plugs 200 and 250 engage and seal the air intake openings 100 and 150 of air box 20 (see FIG. 3), unwanted contaminants can be prevented from entering into air box interior 22. As a result, such contaminants can be prevented from diminishing air flow and otherwise adversely affecting engine operation. It should be noted that an air intake opening, e.g. 100 and 150, of an air box 20 may be of various shapes and sizes. As such, it is expressly contemplated that plugs, e.g. 200 and 250, may be shaped and sized to accommodate the size and shape of individual air intake openings. Furthermore, one or more such plugs can be sized and shaped to engage and seal all of the air intake openings of a given air box.

A representative plug and the manner in which it engages an air intake opening is shown in greater detail in FIG. 4. FIG. 4 shows a partial perspective view of the left side of air box 20, and specifically its air intake opening 100. Air intake opening 100 has a selected air intake profile, in this case representatively depicted as generally triangular. The body 210 of plug 200 is preferably formed from a resilient material such that, upon manual compression, it is formable from an uncompressed state to a compressed state. It should be appreciated that FIG. 4 depicts the body in its uncompressed state prior to being compressed inwardly in the directions shown by the arrows and inserted into the opening. To this end, the plug body can be made of any suitable material for accomplishing such purposes. A preferred material is a neoprene polymer available from Rubberlite Incorporated of Huntington, W. Va. under the designation SCE42NEO. Another rubber compound which can be molded into a desired shape is marketed under the name ReoFlex 30 by Smooth-On, Inc. of Easton, Pa. This material which has the characteristics of durability, washability, ability to conform to slight variances in shape and repel water, is preferred. In the uncompressed state, the body 210 is sized to have a plug profile which is congruent with, and enlarged relative to, the intake profile. Upon compression, and assumption of a compressed state having a compressed plug profile, the body 210 can be inserted into the air intake opening 100. Upon insertion, and in the absence of compressive forces, the resilient material of body 210 returns to its uncompressed state. In returning to the uncompressed state, the body 210 engages and seals the periphery of air intake opening 100, and the opening itself, thereby prevents the passage of unwanted contaminants into the air box interior 22. Of course, the ordinarily skilled artisan will appreciate that the right air intake opening 150 could be sealed in similar fashion.

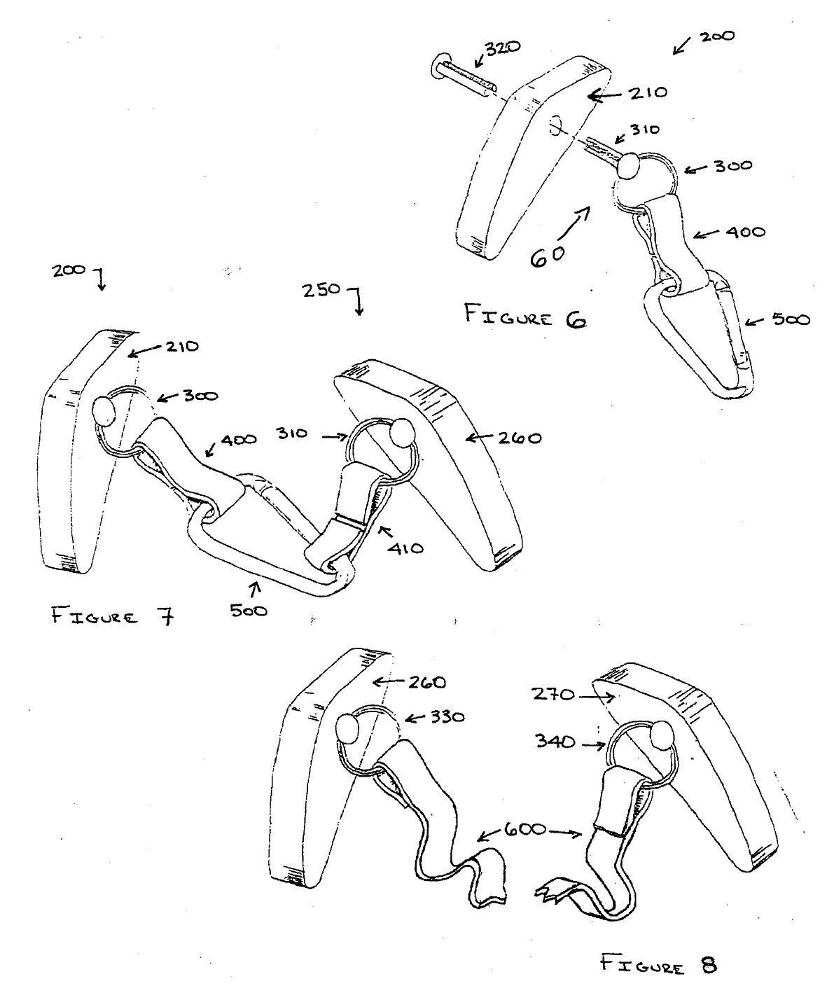

With the above in mind, a first exemplary embodiment of a device is shown in FIGS. 5 & 6. In this exemplary embodiment, at least one plug, such as first plug 200, is joined to a connector assembly 60. As shown in FIGS. 5 and 6, the plug's body 210 is preferably joined to ring 300 by a ratchet rivet having rivet components 310 and 320. The ratchet rivets could, of course, be replaced by other components such as a clevis pin or a metal washer. Ring 300 is connected to a strap portion 400. Thus, together, the ring 300, the ratchet rivet and the strap comprise a connector assembly. Furthermore, it is contemplated that one or more plugs may be releasably joined together by a connector assembly or connector element. For example, as shown in FIG. 7, a second exemplary embodiment for the device comprises a connector assembly which incorporates a second plug 250, having an associated rivet, an associated strap portion 410. The connector assembly also comprises a carabineer 500 for releasably joining the first plug to the second plug.

The first and second plugs shown in FIG. 7 preferably have a common profile, although it is contemplated that plugs of various shapes profiles could be accommodated with such a connector assembly. As such, it is further contemplated that one or more plugs of various profiles could be connected together to seal one or more air boxes with one or more air intake openings having one or more intake profiles. Such an embodiment would permit the accommodation of all the plugs needed to seal one or more air boxes of associated with a variety of motorized vehicles.

FIG. 8 discloses another exemplary embodiment, having a first body 260 and a second body 270 that are joined together by a connector element in the form of a strap 600. The strap 600 is joined to body 260 and body 270 via rings 330 and 340 which, as above, are connected to each body via a ratchet rivet. In this embodiment, strap 600 is sufficiently elongate or flexible to permit body 260 and body 270 to be inserted into their respective openings without becoming disjoined from strap 600. Thus, this embodiment would permit the plugs to engage the air intake openings of an air box while still being attached together. In this embodiment, the connector would straddle the air box during use, such as during a wash cycle.

With an appreciation of the above, it should be appreciated that a method is also contemplated. According to this method, the left and right air intake openings of a motorcycle preferably have a common profile. First and second resilient plugs are provided, each having an associated plug profile which is congruent with, and larger than, the common profile. The first plug is compressed in a direction transverse to the first airflow pathway and inserted into the left opening, whereby the first plug expands toward an uncompressed state to seal the first opening against intrusion of water during the wash cycle. Similarly, the second plug is compressed in a direction transverse to the second airflow pathway and inserted into the right opening, whereby the second plug expands towards an uncompressed state to seal the second opening against intrusion of water during the wash cycle. The order in which the first and second plugs are inserted is of little consequence. Also, according to the method, a connector is provided between the first and second plugs such that when they are inserted into the respective openings, the connector spans therebetween and straddles the seat of a motorcycle.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A device for use on a motorized vehicle which has first and second air intake openings in communication with at least one air filter the first air intake opening having a first intake profile of a first selected shape, and the second air intake opening having a second intake profile of a selected second shape, said device comprising:
a. a first plug having a first plug profile which is congruent with, and enlarged relative to, the first intake profile, said first plug comprising a first body formed from a resilient material such that it is formable into a compressed state for insertion into the first air intake opening and operative to return towards an uncompressed state to seal the first air intake opening against intrusion of contaminants; and
b. a second plug having a second plug profile which is congruent with, and enlarged relative to, the second intake profile, said second plug comprising a second body formed from an associate resilient material such that it is formable into an associated compressed state for insertion into the second air intake opening and operative to return towards an associated uncompressed state to seal the second air intake opening against intrusion of contaminants.

2. A device according to claim 1 including a connector joining said first plug to said second plug.

3. A device according to claim 2 wherein said connector releasably joins said first plug to said second plug.

4. A device according to claim 1 wherein said first plug profile and said second plug profile are the same.

5. A device according to claim 1 wherein each of said first plug profile and said second plug profile is triangular.

6. A device according to claim 1 wherein said first body and said second body are of identical construction.

7. A device according to claim 1 wherein said first plug and the second plug are each formed from the same resilient material.

8. A device according to claim 1 wherein said resilient material is neoprene.

9. A device for use during a wash cycle of a motorcycle which has a left air intake opening in communication with an air filter along a left intake pathway, and a right air intake opening in communication with said air filter along a right intake pathway, the left air intake opening and the right air intake opening having a common profile of a selected shape, said device comprising:
a. a first plug having a first plug profile which is congruent with, and enlarged relative to, said common profile, said first plug comprising a first body formed from a resilient material and manually formable into a compressed state for insertion into the first air intake opening, and operative to return towards an uncompressed state to seal the first air intake opening against intrusion of water during the wash cycle;
b. a second plug having a second plug profile which is congruent with, and enlarged relative to, said common profile, said second plug comprising a second body formed from said resilient material and manually formable into a compressed state for insertion into the second air intake opening, and operative to return towards an uncompressed state to seal the second air intake opening against intrusion of water during the wash cycle; and
c. a connector assembly joining said first plug to said second plug.

10. A device according to claim 9 wherein said connector assembly includes at least one strap portion.

11. A device according to claim 10 wherein said connector assembly includes a pair of strap portions, each mounted to an associated said plug and coupled together by a connector element.

12. A device according to claim 11 wherein said connector element is a carabiner.

13. A device according to claim 11 wherein said strap portions are removably received on said connector element.

14. A device according to claim 9 wherein said connector assembly is sufficiently elongate to permit said first and second plugs to be inserted into their respective openings without becoming disjoined from said connector element.

15. A device according to claim 9 wherein said common profile has a triangular shape.

16. A device for use during a wash cycle of a motorcycle, comprising:
a. a first compressible plug for removable insertion into a first air intake opening of the motorcycle to seal the first air intake opening against intrusion of water during the wash cycle;
b. a second compressible plug for removable insertion into a second air intake opening to seal the second air intake opening against intrusion of water during the wash cycle; and
c. an elongate connector joining said first plug to said second plug.

17. A method for use during a wash cycle of a motorcycle which has a left air intake opening in communication with a first air filter along a first airflow pathway, and a right air intake opening in communication with a second air filter along a second airflow pathway, the left and right openings having a common profile, said method comprising:
a. providing a first resilient plug having a first plug profile which is congruent with, and larger than, the common profile;
b. providing a second resilient plug having a second plug profile which is congruent with, and larger than, the common profile;
c. compressing said first plug in a direction transverse to said first airflow pathway and inserting said first plug into said left opening, whereby said first plug expands toward an uncompressed state to seal the first opening against intrusion of water during the wash cycle; and
d. compressing said second plug in a direction transverse to said second airflow pathway and inserting said second plug into said right opening, whereby said second plug expands toward an uncompressed state to seal the second opening against intrusion of water during the wash cycle.

18. A method according to claim 17 comprising providing a connector between said first and second plugs and inserting said first and second plugs into their respective openings such that said connector spans therebetween and straddles a seat of the motorcycle.

19. A method according to claim 18 comprising fastening said connector to said plug along an axis that is substantially parallel with said airflow pathway.

20. A device for use on a motorized vehicle which has at least a first air intake opening in communication with at least one air filter, said first air intake opening having a first intake profile of a first selected shape, said device comprising:
a. at least a first plug having a first plug profile which is congruent with, and enlarged relative to, the first intake profile, said first plug comprising a first body formed from a resilient material such that it is formable into a compressed state for insertion into the first air intake opening and operative to return towards an uncompressed state to seal the first air intake opening against intrusion of contaminants; and
b. a connector element joined to said first plug.

21. A device according to claim 2 wherein said motorized vehicle has a second air intake opening in communication with the air filter, said second air intake opening having a second intake profile of a second selected shape, further comprising a second plug joined to said first plug by said connector element, said second plug having a second plug profile which is congruent with, and enlarged relative to, the second intake profile, said second plug comprising a second body formed from an associate resilient material such that it is formable into an associated compressed state for insertion into the second air intake opening and operative to return towards an associated uncompressed state to seal the second air intake opening against intrusion of contaminants.
